(19) United States
(12) Patent Application Publication
(10) Pub. No.: US 2011/0226997 A1
(43) Pub. Date: Sep. 22, 2011

(54) Method And System Of Gasification

(75) Inventors: Tunc Goruney, Bethlehem, PA (US); Pinar Guvelioglu, Macungie, PA (US); Simone L. Kothare, Slatington, PA (US)

(73) Assignee: AIR PRODUCTS AND CHEMICALS, INC., Allentown, PA (US)

(21) Appl. No.: 12/727,362

(22) Filed: Mar. 19, 2010

(51) Int. Cl. C01B 3/32; B01J 19/00

(52) U.S. Cl. 252/373; 422/187

(57) ABSTRACT

Disclosed is a system and method for gasification. The method includes partially oxidizing a concentrated lignin-containing liquor to form a product gas and a particulate, separating the product gas from the particulate, and contacting a lignin-containing liquor feed with the separated product gas. The contacting forms the concentrated lignin-containing liquor. The concentrated lignin-containing liquor includes dry solids content of less than about 65% and a sulfur content of less than about 2%.

### BACKGROUND OF THE INVENTION

The present invention is directed to methods and systems of gasification. More specifically, the present invention is directed to methods and systems of gasification for producing synthesis gas from low sulfur, low solid content lignin sources.

By-products generated by various process installations (for example, pulp mills, paper mills, and biorefineries) can be environmentally harmful and/or may require additional expenditures for handling or further processing. Pulp and paper mills are a major source of environmental impact due to the pulping process. During the pulping process, wood chips are dissolved into individual fibers by chemical, semi-chemical, and/or mechanical methods. For example, wood chips may be ground and bleached.

The majority of paper products are produced by chemical pulping (for example, by the Kraft process). For example, U.S. Pat. No. 4,808,264, which is hereby incorporated by reference in its entirety, discloses chemical pulping involving degrading wood by dissolving lignin bonds that hold cellulosic fibers together. The process can include using a sodium-based alkaline pulping solution consisting of sodium and sodium hydroxide to generate a pulp and a liquid containing the dissolved lignin solids in a solution of reacted and unreacted pulping chemicals. The solution may be referred to as black liquor and may be high in sulfur (for example, between about 3% and about 8%, or at about 5%), thereby rendering the solution less desirable for certain applications.

Paper mills may use the black liquor as an energy source by combusting the black liquor in boilers to generate steam and to recover chemicals used in the pulping process (for example, sodium hydroxide and sodium sulfide). For example, the paper mills may use a boiler (for example, a recovery boiler such as a Tomlinson boiler that is part of the Kraft process) and/or a gasifier (for example, an entrained flow gasifier such as a Chemrec gasifier).

Lignin-containing liquor may also be produced in biorefineries (for example, cellulosic ethanol producing facilities). The biorefineries may be fed wood waste, corn stover, rice hulls, sugar cane bagasse, crop residues, etc. The process may include biochemical processes (for example, combining hydrolysis, enzymatic conversion, fermentation, and separation steps) to produce hydrolysis lignin. The hydrolysis lignin contains about 30% to 50% of the original biomass feed weight. The hydrolysis lignin may be used as fuel for combustion in boilers, in forming animal feed, and/or in forming bioplastics.

Alternatively, the hydrolysis lignin may be used in the production of synthesis gas to generate heat, power, and biofuels. In converting synthesis gas to cellulosic biofuels, the process begins with lignin gasification where a product gas (for example, primarily CO, CO2, and H2) is produced and directed into a catalytic or biochemical conversion reactor. Processes of converting synthesis gas to biofuel may involve anaerobic microorganisms and a bioreactor for the biochemical conversion. However, such processes may suffer from the drawback of having limited application based upon alcohol productivity being insufficient, based upon synthesis gas contamination, and/or based upon the amount of mass transfer being insufficient.

International Application WO9737944, which is hereby incorporated by reference in its entirety, discloses full oxidation of spent liquors. For example, the full oxidation generates a product gas substantially devoid of combustible fuel. Such full oxidation allows product gas to be used for steam generation. Other uses of the product gas are limited.

What is needed is a method and system for producing synthesis gas from low sulfur, low solid content lignin sources.

### BRIEF SUMMARY OF THE INVENTION

In an exemplary embodiment, a method of gasification includes partially oxidizing a concentrated lignin-containing liquor to form a product gas and a particulate, separating the product gas from the particulate, and contacting a lignin-containing liquor feed with the separated product gas. The contacting forms the concentrated lignin-containing liquor. The concentrated lignin-containing liquor includes dry solids content of less than about 65% and a sulfur content of less than about 2%.

Embodiments of the method can include the separating occurring by impingement of the particulate on walls of a reactor and by gravity. A further embodiment includes contacting at least a portion of the particulate with a quench liquid in a vessel, the contacting generating steam thereby preventing the product gas from entering the vessel. Another embodiment includes the low dry solids content including a concentration of solids between about 30% and about 65%. Additionally or alternatively, the partial oxidation can be performed by an oxygen stream of at least 90% oxygen. In another embodiment with the partial oxidation occurring in a reactor, the separating begins in the reactor and is substantially completed by the product gas flowing through a separator to a vessel. A further embodiment includes the contacting of the lignin-containing liquor feed to the separated product gas occurring in the vessel. In an even further embodiment, a portion of the concentrated lignin-containing liquor flows from the vessel toward the reactor. Alternatively, the particulate is substantially prevented from entering the separator.

In another exemplary embodiment, a gasification system includes a reactor, an evaporator vessel, and a separator. The reactor is arranged and disposed to partially oxidize a concentrated lignin-containing liquor to form a product gas and a particulate, and the reactor is arranged and disposed to separate the product gas from the particulate. The evaporator vessel is arranged and disposed to receive the product gas from the reactor and to contact the product gas with a lignin containing liquid in the evaporator vessel. The separator is positioned between the reactor and the evaporator vessel, the separator being configured to substantially prevent the particulate from entering the evaporator vessel. The concentrated lignin-containing liquor includes dry solids content of less than about 65% and a sulfur content of less than about 2%.

Embodiments of the system can include the reactor being positioned to separate the particulate from the product gas by impingement of the particulate on walls of the reactor and by gravity. The quenching vessel can contacts at least a portion of the particulate with a quench liquid, the contacting generating steam thereby preventing the product gas from entering the quenching vessel. Additionally or alternatively, the system can include the low dry solids content including a concentration of solids between about 35% and about 65%, the system can include an oxygen stream of at least 90% oxygen for partial oxidation of the concentrated lignin-containing liquor, and/or a portion of the lignin-containing liquor can flow from the evaporator vessel toward the reactor.

Embodiments of the system can include a separator between the reactor and the evaporator vessel, the separator substantially preventing the particulate from entering the evaporator vessel. A further embodiment, can include the separator including an upward flow path. Additionally or alternatively, the separator can include a screen and/or a refractory cap for distributing heat.

In another exemplary embodiment, a gasification system includes a reactor including a burner configured for partial oxidation of a concentrated lignin-containing liquor forming and separating a product gas and a particulate, a quenching vessel for contacting at least a portion of the particulate with a quench liquid, an evaporator vessel for contacting a lignin-containing liquor feed with the separated product gas to form a concentrated lignin-containing liquor, and a conduit from the evaporator vessel to the burner. The contacting generating steam prevents the product gas from entering the quenching vessel. The conduit is configured to transport a portion of the concentrated lignin-containing liquor. The remaining portion of the concentrated lignin-containing liquor flows from the evaporator vessel. The concentrated lignin-containing liquor includes dry solids content of less than about 65% and a sulfur content of less than about 2%.

An advantage of the present disclosure includes cooled reactor walls allowing for reducing or eliminating costly refractory material and/or extending the life of a refractory wall.

Another advantage of the present disclosure includes reduced downstream evaporation costs and increased efficiency.

Another advantage of the present disclosure includes more efficient production of synthesis gas.

Another advantage of the present disclosure includes reduced or eliminated contact of gas product with dissolved slag.

Another advantage of the present disclosure includes shifting production of gas from CO to H2 and CO2.

Another advantage of the present disclosure includes reduced or eliminated burner clogging by having a relatively low dry solids content between about 30% and about 65% and by maintaining a concentrated lignin-containing liquor at a temperature resulting in a low enough viscosity to pump the concentrated lignin-containing liquor into a burner.

Other features and advantages of the present invention will be apparent from the following more detailed description of the preferred embodiment, taken in conjunction with the accompanying drawings which illustrate, by way of example, the principles of the invention.

### BRIEF DESCRIPTION OF SEVERAL VIEWS OF THE DRAWINGS

FIG. 1 shows an exemplary gasification system according to an embodiment of the disclosure.

FIG. 2 show an enlarged portion of FIG. 1 showing an exemplary separator according to an embodiment of the disclosure.

Wherever possible, the same reference numbers will be used throughout the drawings to represent the same parts.

### DETAILED DESCRIPTION OF THE INVENTION

Provided is a method and system of gasification for producing synthesis gas from a broad range of low sulfur, low solid content lignin sources. As used herein, the phrase “low sulfur” and grammatical variations thereof refer to less than about 2% sulfur by weight. As used herein the phrase “low solid content” and grammatical variations thereof refer to a solid content below about 65% by weight. As used herein, the phrase “partial oxidation” and grammatical variations thereof refer to fuel-rich operating conditions (for example, substoichiometric conditions/operating with a stoichiometric ratio of less than about 1). As used herein, the term “gas” and grammatical variations thereof includes any fluid or vapor.

Embodiments of the present disclosure can permit partial oxidation, can cool reactor walls, can reduce downstream evaporation costs, can reduce or eliminate burner clogging, can permit increased production of synthesis gas, can reduce or eliminate gas product contacting dissolved slag, and/or can shift production of gas from CO to H2 and CO2.

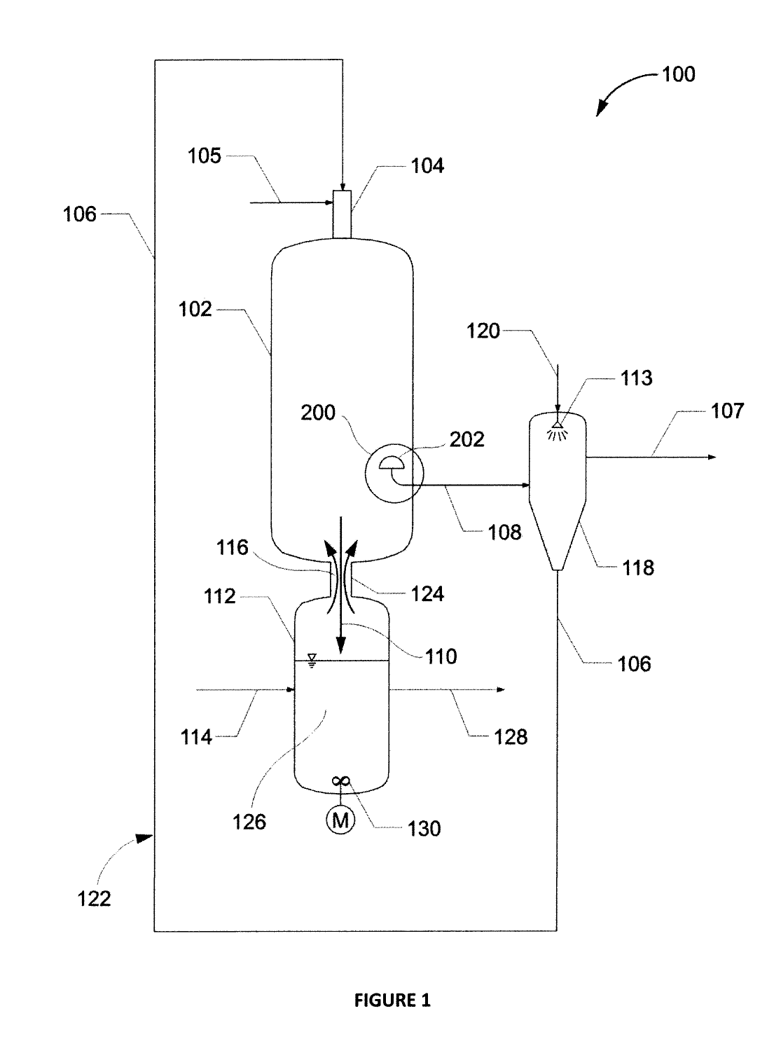

Referring to FIG. 1, reactor 102 includes a burner 104. Burner 104 partially oxidizes a concentrated lignin-containing liquor 106. The partial oxidation occurs by selectively supplying an oxidizer 105 to burner 104 and introducing the oxidizer 105 to concentrated lignin-containing liquor 106. Generally, oxidizer 105 is an oxygen containing gas, for example, in the form of vacuum swing adsorption (VSA) or liquid oxygen. The oxidizer includes about 90% to about 95% oxygen or at least 90% oxygen. In one embodiment, the partial oxidation is performed under superatmospheric pressure, with a stoichiometric ratio of about 0.45, and with the temperature within reactor 102 being about 950° C.

The partial oxidation forms a product gas 108 and a particulate 110 (for example, molten slag). Product gas 108 includes H2, CO, CO2, and H2O. The particulate 110 includes inorganic substances melted through the partial oxidation. The particulate 110 separates from product gas 108. The separation can occur based upon the particulate 110 having a greater density (for example, between 1100 kg/m3 and 2000 kg/m3, or about 1200 kg/m3) and product gas 108 having a lower density (for example, between 1.5 kg/m3 and 3.5 kg/m3, or about 2.4 kg/m3) at a predetermined temperature (for example, 950° C.) and a predetermined pressure (for example, 10 bar).

A portion of particulate 110 flows to a quenching vessel 112. In an exemplary embodiment, quenching vessel 112 is positioned below reactor 102 and a channel 124 extends between reactor 102 and quenching vessel 112. In the exemplary embodiment, particulate 110 flows to quenching vessel 112 by gravity. Additionally or alternatively, particulate 110 can flow to quenching vessel 112 by centrifugal force provided by introducing a tangential flow stream or using a cyclonic reactor. Other suitable separations systems permitting separation based upon differing densities and/or differing phases can be additionally or alternatively used.

Within quenching vessel 112, particulate 110 contacts quench liquid 126 (for example, a slurry containing water). At start-up, quench liquid 126 is substantially devoid of particulate 110. During operation, a concentration of particulate 110 within quench liquid 126 increases. At least a portion of the particulate 110, which can be molten, dissolves in quench liquid 126. Upon particulate 110 contacting quench liquid 126, water within quench liquid 126 converts into steam.

Concentration of quench liquid 126 can be maintained at a predetermined concentration. The concentration of particulate 110 within quench liquid 126 can be adjusted by the amount of water and/or the amount of particulate 110 forming quench liquid 126. For example, the concentration can be maintained and/or adjusted by selectively providing water from water stream 114 to quench vessel 112. Water from water stream 114 can, thus, decrease the concentration of particulate 110 in quench liquid 126 of quenching vessel 112.

Quench liquid 126 can include soluble materials (for example, soluble molten slag) and/or insoluble materials (for example, insoluble molten slag). Insoluble materials can be removed from quench liquid 126 by any suitable physical separation mechanism (for example, a filter and/or a centrifuge) to form a solution 128. The solution 128 includes the quench liquid 126 and soluble materials (for example, soluble slag mixed with water 114 in solution such as water-sodium carbonate solution or Na2CO3 (aq)). Solution 128 includes chemicals necessary for additional downstream processes and can be recovered by and/or transferred to the additional processes. The concentration of soluble and/or insoluble materials within solution 128 can be maintained and/or adjusted by selectively controlling flow of solution 128 from quenching vessel 112. The rate that solution 128 flows from quenching vessel 112 can be increased or decreased, thus, permitting the concentration of soluble and/or insoluble materials in quench liquid 126 to be increased or decreased. Additionally, the flow rate of solution 128 exiting quenching vessel 112 can be increased to maintain a level of quench liquid 126 below a predetermined level in quenching vessel 112 and/or the flow rate of solution 128 exiting quenching vessel 112 can be decreased to maintain a level of quench liquid 126 above a predetermined point in quenching vessel 112. Likewise, the flow rate of water from water stream 114 can be increased to maintain a level of quench liquid 126 above a predetermined level in quenching vessel 112 and/or the flow rate of quench liquid 126 can be decreased to maintain a level of quench liquid 126 below a predetermined level in quenching vessel 112.

In an exemplary embodiment, quenching vessel 112 includes an impeller 130 for agitating quench liquid 126. Agitation of quench liquid 126 can prevent the temperature of quenching vessel 112 from exceeding a predetermined temperature by promoting steam generation. In one embodiment, the steam generation is promoted by quenching the molten slag. In this embodiment, contact of product gas with dissolved slag in quenching vessel 112 can be reduced, thereby preventing the temperature of quenching vessel 112 from exceeding a predetermined temperature (for example, about 180° C. at 10 bar). In one embodiment, the speed of rotation for impeller 130 is increased upon the temperature of quench liquid 126 reaching a predetermined amount. Similarly, the rate of new water from water stream 114 being introduced into quenching vessel 112 and the rate of solution 128 flowing from quenching vessel 112 can be adjusted based upon the temperature of quench liquid 126. Such temperature control can permit quenching vessel 112 to be of a lower temperature rated material, thereby resulting in cost savings. For example, “Stainless Steel 304”, which has lower temperature ratings than “Stainless Steel 316” and costs less than “Stainless Steel 316”, can be used instead of “Stainless Steel 316”. The cost savings can be determined based upon the shape, complexity, and size of the material.

Arrangement of quenching vessel 112 in relation to reactor 102 substantially prevents product gas 108 from entering quenching vessel 112. For example, when particulate 110 contacts water to form quench liquid 126, steam 116 is released. Steam 116 travels through channel 124 between quenching vessel 112 and reactor 102. As steam 116 flows upward through channel 124, gases are substantially prevented from entering quenching vessel 112 through channel 124. For example, product gas 108 can have a density lower than steam 116 and, thus, be substantially prevented from flowing downward through channel 124 while steam 116 is flowing upward through channel 124. Additionally or alternatively, steam 116 can have a momentum that substantially prevents downward flow of product gas 108 through channel 124 while steam 116 is flowing upward through channel 124. An additional portion of particulate 110 can impinge on inner walls of reactor 102. The additional portion of particulate 110 can, thus, be captured and separated from product gas 108. Thus, the presence of product gas 108 within quenching vessel 112 can be reduced or eliminated.

Reducing or eliminating the presence of product gas 108 within quenching vessel 112 reduces or eliminates the amount of product gas 108 (or components of product gas 108, such as CO and/or CO2) entering quench liquid 126 and/or solution 128 and, thus, reduces or eliminates causticization load in additional downstream processes (for example, processes associated with chemical recovery).

In one embodiment, a downstream process associated with chemical recovery involves recovering NaOH. In general, direct contact of CO2 with solution 128 (for example, water-sodium carbonate solution) forms carbonate. Carbonate may further react with CO2 to form bicarbonate. The formation of bicarbonate permits recovery of NaOH (which can be a desired chemical to be recovered).

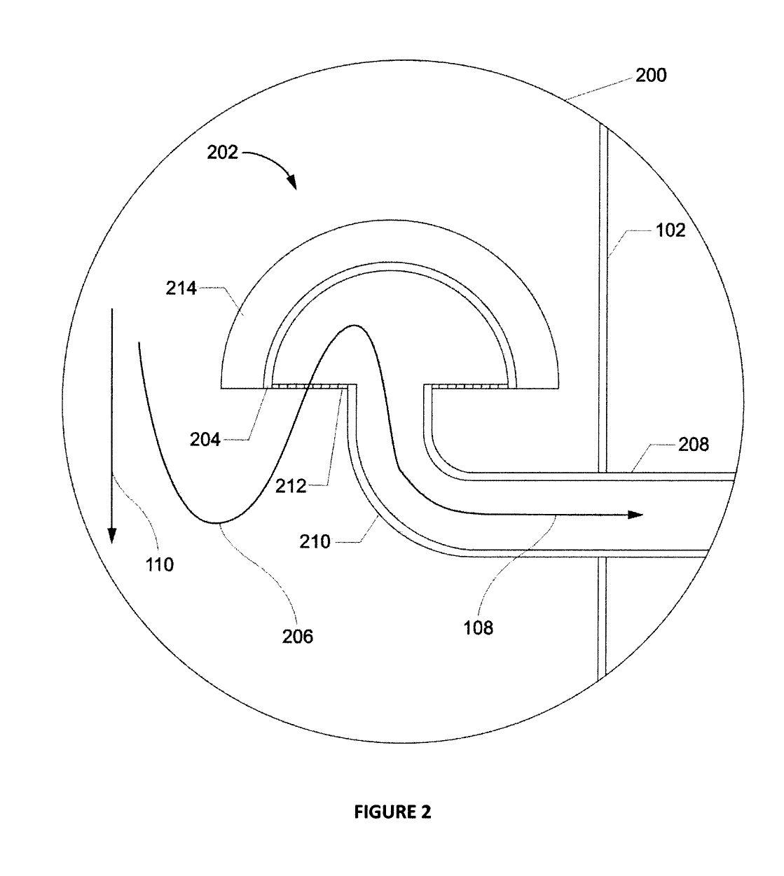

Product gas 108 flows to evaporator vessel 118 from reactor 102. Referring to FIG. 2, in an exemplary embodiment (shown as enlarged area 200), product gas 108 flows through a separator 202. Separator 202 is positioned within reactor 102 and in fluid communication with evaporator vessel 118. In other embodiments, separator 202 is positioned along a wall or reactor 102. Separator 202 substantially prevents particulate 110 from entering evaporator vessel 118. Separator 202 includes an upward facing flow path 206 defined by a cap 204 preventing particulate 110 from entering separator 202 from above. Upward flow path 206 is formed by a shielding arrangement 214, which can have a mushroom-like geometry, with cap 204 housing a porous or open interior portion fluidly connected to a pipe 208 that is in fluid communication with evaporator vessel 118 (shown in FIG. 1).

In one embodiment, separator 202 includes a substantially perpendicular (for example, about 90°) bend 210. The angle of bend 210 affects the amount of particulate 110 entering pipe 208 and, thus, the amount of particulate 110 entering evaporator vessel 118. In one embodiment, separator 202 includes a screen 212 further preventing particulate 110 from entering pipe 208 and/or evaporator vessel 118. In another embodiment, separator 202 includes shielding arrangement 214 of refractory material to protect cap 204 from temperatures of particulate 110 and/or reactor 102. In another embodiment, separators 202 include a water jacket (not shown) to protect cap 204 from increased temperatures. Similarly, pipe 208 can include refractory material and/or the water jacket. Other suitable separation mechanisms can be used for preventing particulate 110 from entering evaporator vessel 118.

Upon product gas 108 entering evaporator vessel 118, product gas 108 contacts lignin-containing liquor feed 120. The lignin in the lignin-containing liquor feed 120 is an organic polymer and can have low sulfur content (less than 1% by weight) or have sulfur content below 0.5% by weight. The lignin-containing liquor feed 120 can be formed by digestion pulpwood and digestion chemicals. Contacting product gas 108 with lignin-containing liquor feed 120 quenches product gas 108. Inorganic substances (for example, inorganic solids), which remain in product gas 108 (thus, not captured in reactor 102 and/or quenching vessel 112) are captured by lignin-containing liquor feed 120. Evaporated water vapor from lignin-containing liquor feed 120 then mixes with product gas 108. Upon being quenched, product gas 108 forms product gas 107 which can be stored or used. Product gas 107 can be further processed by clean-up, non-selective acid gas removal by a pressure swing adsorption unit, energy recovery, fuel system, and/or any other suitable system or combination of systems. For example, product gas 107 can be used in energy production systems focused on steam, electrical power, fuel, and/or hydrogen generation.

In an exemplary embodiment, lignin-containing liquor feed 120 is provided to evaporator vessel 118 by any suitable mechanism. For example, lignin-containing liquor feed 120 can be provided to evaporator vessel 118 by a spray mechanism 113 having a nozzle for increased dispersion within evaporator vessel 118. Lignin-containing liquor feed 120 can be provided at a predetermined temperature (for example, between about 100° C. and 140° C., or about 120° C.). In one embodiment, the predetermined temperature of lignin-containing liquor feed 120 is based upon the boiling temperature of lignin-containing liquor feed 120. For example, the predetermined temperature is set to be within 10° C. of the boiling temperature of lignin-containing liquor feed 120. Product gas 108 enters evaporator vessel 118 at a predetermined temperature (for example, between about 140° C. and 200° C., or about 180° C.). Increased dispersion of the spray mechanism 113 improves heat transfer between product gas 108 and lignin-containing liquor feed 120, thereby improving the rate of concentrating lignin-containing liquor feed 120.

Upon product gas 108 entering evaporator vessel 118 and lignin-containing liquor feed 120 being heated to a predetermined temperature by the quenching of product gas 108, the concentration of lignin-containing liquor feed 120 is increased to a predetermined range. For example, the dry solids content of lignin-containing liquor feed 120 may be increased from the range of about 35% to about 65%, between about 45% and about 65%, or about 65% forming concentrated lignin-containing liquor 106. Concentrated lignin-containing liquor 106 may be provided to burner 104 by a conduit 122 from evaporator vessel 118. In one embodiment, the predetermined range, being low in solid content, may provide cooling to walls of reactor 102 and/or protection from corrosion. The cooling and/or corrosion resistance may be achieved by the formation of a solidified slag layer on the wall of reactor 102.

In one embodiment, the water content of the concentrated lignin-containing liquor 106 is in the predetermined range, thereby shifting concentration of CO within product gas 108 to H2 and CO2. In a further embodiment, a water gas shift reactor (not shown) is fluidly connected downstream of reactor 102 to promote hydrogen production and/or shift the concentration of CO within product gas 108 to H2 and CO2. To monitor and/or control the promotion of hydrogen production and/or the shift of concentration of CO within product gas 107 to H2 and CO2, steam input can be monitored and/or adjusted. The H2 generated can be used in applications such as fuel cell, fuel synthesis, substitute natural gas production, and/or other suitable processes. The CO2 generated can be used for neutralization of concentrated lignin-containing liquor 106. For example, the neutralization of concentrated lignin-containing liquor 106 can involve contacting of CO2 containing gas with a black liquor in order to precipitate silica and lignin from the black liquor.

In one embodiment, concentrated lignin-containing liquor 106 can be at a predetermined temperature for improving combustion within reactor 102 to reduce (or eliminate) the complexity and/or cost of downstream evaporation systems/sub-systems. For example, if the predetermined temperature is at or near a boiling point of concentrated lignin-containing liquor 106, systems/sub-systems for substantially increasing the temperature of concentrated lignin-containing liquor 106 can be eliminated. Additionally or alternatively, if the predetermined temperature is high enough (for example, between about 140° C. and 200° C., or about 180° C.), clogging of the burner 104 can be reduced or eliminated. For example, the temperature can correspond to a predetermined viscosity of concentrated lignin-containing liquor 106, the predetermined viscosity being capable of reducing or eliminating burner 104 clogging.

In an exemplary embodiment, partial oxidation of concentrated lignin-containing liquor 106 forms product gas 108 and particulate 110. Product gas 108 and particulate 110 are separated. Then, lignin-containing liquor feed 120 is applied to the separated product gas 108 forming product gas 107 and concentrated lignin-containing liquor 106. Concentrated lignin-containing liquor 106 can be recycled for further partial oxidation, and product gas 107 can be used for additional purposes.

### Examples

In a first example, lignin-containing liquor feed 120, with dry solids content of about 30%, is pumped at a rate of about 0.140 kg/s into evaporator vessel 118. Water vapor is evaporated in evaporator vessel 118 by lignin-containing liquor feed 120. The dry solids content is increased to about 44% and to a temperature of about 175° C. Concentrated lignin-containing liquor 106 is then provided to burner 104. About 0.042 kg/s of oxygen is also introduced to reactor 102. The temperature in the reactor 102 is about 950° C. and the pressure is about 10 bar. The reaction products formed are about 0.048 kg/s of inorganic molten slag and about 0.380 kg/s of product gas. The product gas includes about 0.042 kg/s of CO, 0.005 kg/s of H2, 0.066 kg/s of CO2, and 0.268 kg/s of H2O. At a temperature of 950° C. and a pressure of 10 bar, product gas 108 includes a flow rate that corresponds to about 0.178 m3/s. The flow of molten slag is about 40 cm3/s.

In a second example, water having a salt concentration of about 30% is provided to quenching vessel 112 and added from water stream 114 at a rate of about 0.020 kg/s. The added water evaporates at a rate of about 0.004 kg/s due to the molten slag quenching in the quenching vessel 112. At 10 bar, water vapor (steam) having a temperature of about 180° C. includes a flow rate of about 0.9 dm3/s. After direct evaporation in evaporator vessel 118, product gas 107 includes about 0.152 kg/s more H2O than product gas 108. At a temperature of about 180° C. and a pressure of 10 bar, product gas 107 includes a flow rate of about 0.077 m3/s.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method of gasification, the method comprising:
partially oxidizing a concentrated lignin-containing liquor, the partial oxidation forming a product gas and a particulate;
separating the product gas from the particulate;
contacting a lignin-containing liquor feed with the separated product gas, the contacting forming the concentrated lignin-containing liquor; and
wherein the concentrated lignin-containing liquor includes dry solids content of less than about 65% and a sulfur content of less than about 2%.

2. The method of claim 1, wherein the separating occurs by impingement of the particulate on walls of a reactor and by gravity.

3. The method of claim 2, further comprising contacting at least a portion of the particulate with a quench liquid in a vessel, the contacting generating steam thereby preventing the product gas from entering the vessel.

4. The method of claim 1, wherein the low dry solids content includes a concentration of solids between about 35% and about 65%.

5. The method of claim 1, wherein the partial oxidation is performed by an oxygen stream of at least 90% oxygen.

6. The method of claim 1, wherein the partial oxidation occurs in a reactor, and wherein the separating begins in the reactor and is substantially completed by the product gas flowing through a separator to a vessel.

7. The method of claim 6, wherein the contacting of the lignin-containing liquor feed to the separated product gas occurs in the vessel.

8. The method of claim 7, wherein a portion of the concentrated lignin-containing liquor flows from the vessel toward the reactor.

9. The method of claim 6, wherein the particulate is substantially prevented from entering the separator.

10. A gasification system, the system comprising:
a reactor, the reactor being arranged and disposed to partially oxidize a concentrated lignin-containing liquor to form a product gas and a particulate, and the reactor being arranged and disposed to separate the product gas from the particulate;
an evaporator vessel arranged and disposed to receive the product gas from the reactor and to contact the product gas with a lignin containing liquid in the evaporator vessel; and
a separator positioned between the reactor and the evaporator vessel, the separator being configured to substantially prevent the particulate from entering the evaporator vessel;
wherein the concentrated lignin-containing liquor includes dry solids content of less than about 65% and a sulfur content of less than about 2%.

11. The system of claim 10, wherein the reactor is positioned to separate the particulate from the product gas by impingement of the particulate on walls of the reactor and by gravity.

12. The system of claim 10, further comprising a quenching vessel in fluid communication with the reactor, wherein the quenching vessel is configured to contact at least a portion of the particulate with a quench liquid, the contacting generating steam thereby preventing the product gas from entering the quenching vessel.

13. The system of claim 10, wherein the low dry solids content includes a concentration of solids between about 30% and about 65%.

14. The system of claim 10, further comprising an oxygen stream of at least 90% oxygen for performing the partial oxidation of the concentrated lignin-containing liquor.

15. The system of claim 10, arranged for a portion of the lignin-containing liquor to flow from the evaporator vessel toward the reactor.

16. The system of claim 10, further comprising a separator between the reactor and the evaporator vessel, the separator substantially preventing the particulate from entering the evaporator vessel.

17. The system of claim 16, wherein the separator includes an upward flow path.

18. The system of claim 16, wherein the separator includes a screen.

19. The system of claim 16, wherein the separator includes a refractory cap for distributing heat.

20. A gasification system, the system comprising:
a reactor, the reactor being arranged and disposed to partially oxidize a concentrated lignin-containing liquor to form a product gas and a particulate, and the reactor being arranged and disposed to separate the product gas from the particulate;
an evaporator vessel arranged and disposed to receive the product gas from the reactor and to contact the product gas with a lignin containing liquid in the evaporator vessel;
a separator positioned between the reactor and the evaporator vessel, the separator being configured to substantially prevent the particulate from entering the evaporator vessel; and
a quenching vessel in fluid communication with the reactor;
wherein the concentrated lignin-containing liquor includes dry solids content of between about 30% and about 65% and a sulfur content of less than about 2%;
wherein the reactor is positioned to separate the particulate from the product gas by impingement of the particulate on walls of the reactor and by gravity;
wherein the quenching vessel is configured to contact at least a portion of the particulate with a quench liquid, the contacting generating steam thereby preventing the product gas from entering the quenching vessel.
